(19) United States
(12) Patent Application Publication
(10) Pub. No.: US 2012/0140716 A1
(43) Pub. Date: Jun. 7, 2012

(54) Method and Arrangement for Transmitting Uplink Control

(75) Inventors: Robert Baldemair, Solna (SE); Jung-Fu Cheng, Fremont, CA (US); Dirk Gerstenberger, Stockholm (SE); Daniel Larsson, Solna (SE)

(73) Assignee: TELEFONAKTIEBOLAGET L M ERICSSON (PUBL), Stockholm (SE)

(21) Appl. No.: 13/175,569

(22) Filed: Jul. 1, 2011

Related U.S. Application Data
(63) Continuation of application No. PCT/SE2011/050251, filed on Mar. 7, 2011.
(60) Provisional application No. 61/431,916, filed on Jan. 12, 2011.
(60) Provisional application No. 61/431,504, filed on Jan. 11, 2011.
(60) Provisional application No. 61/419,397, filed on Dec. 3, 2010.

(51) Int. Cl. H04W 72/04

(52) U.S. Cl. 370/329

(57) ABSTRACT

In various embodiments, a method for transmitting uplink control information in a cell is provided. The uplink control information is transmitted during a time slot. According to this method, bits corresponding to uplink control information are mapped to complex modulation symbols. The complex modulation symbols are spread in the time slot using a set of orthogonal cover code, OCC, sequences, such that at least two of the complex modulation symbols are spread using different OCC sequences. The uplink control information is then transmitted using said spread complex modulation symbols.

### TECHNICAL FIELD

The present invention relates generally to telecommunications systems, and in particular, to methods, systems, devices and software for transmitting uplink control information in radio communications systems.

### BACKGROUND

Radio communication networks were originally developed primarily to provide voice services over circuit-switched networks. The introduction of packet-switched bearers in, for example, the so-called 2.5G and 3G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Also to provide the capabilities needed to support next generation radio communication applications, while at the same time using legacy infrastructure, network operators could deploy hybrid networks wherein a next generation radio communication system is overlaid onto an existing circuit-switched or packet-switched network as a first step in the transition to an all IP-based network. Alternatively, a radio communication system can evolve from one generation to the next while still providing backward compatibility for legacy equipment.

One example of such an evolved network is based upon the Universal Mobile Telephone System (UMTS) which is an existing third generation (3G) radio communication system that is evolving into High Speed Packet Access (HSPA) technology. Yet another alternative is the introduction of a new air interface technology within the UMTS framework, e.g., the so-called Long Term Evolution (LTE) technology. Target performance goals for LTE systems include, for example, support for 200 active calls per 5 MHz cell and sub 5 ms latency for small IP packets. Each new generation, or partial generation, of mobile communication systems add complexity and abilities to mobile communication systems and this can be expected to continue with either enhancements to proposed systems or completely new systems in the future.

LTE uses orthogonal frequency division multiplexing (OFDM) in the downlink and discrete Fourier transform (DFT)-spread OFDM in the uplink. The basic LTE downlink physical resource can thus be seen as a time-frequency grid as illustrated in FIG. 1, where each resource element corresponds to one OFDM subcarrier during one OFDM symbol interval. In the time domain, LTE downlink transmissions are organized into radio frames of 10 ms, each radio frame consisting of ten equally-sized subframes of length T_{subframe}=1 ms as shown in FIG. 2.

Furthermore, the resource allocation in LTE is typically described in terms of resource blocks, where a resource block corresponds to one slot (0.5 ms) in the time domain and 12 subcarriers in the frequency domain. Resource blocks are numbered in the frequency domain, starting with 0 from one end of the system bandwidth. Downlink transmissions are dynamically scheduled, i.e., in each subframe the base station (typically referred to as an eNB in LTE) transmits control information indicating to which terminals and on which resource blocks the data is transmitted during the current downlink subframe. This control signaling is typically transmitted in the first 1, 2, 3 or 4 OFDM symbols in each subframe. A downlink system with 3 OFDM symbols as the control region is illustrated in FIG. 3.

LTE uses hybrid-ARQ where, after receiving downlink data in a subframe, the terminal attempts to decode it and reports to the base station whether the decoding was successful (ACK) or not (NAK). In case of an unsuccessful decoding attempt, the base station can retransmit the erroneous data. Uplink control signaling from the terminal to the base station thus consists of: hybrid-ARQ acknowledgements for received downlink data; terminal reports related to the downlink channel conditions, used as assistance for the downlink scheduling (also known as Channel Quality Indicator (CQI)); and scheduling requests, indicating that a mobile terminal needs uplink resources for uplink data transmissions.

If the mobile terminal has not been assigned an uplink resource for data transmission, the L1/L2 control information (channel-status reports, hybrid-ARQ acknowledgments, and scheduling requests) is transmitted in uplink resources (resource blocks) specifically assigned for uplink L1/L2 control information on the Physical Uplink Control Channel (PUCCH). Different PUCCH formats are used for the different information, e.g. PUCCH Format 1a/1b are used for hybrid-ARQ feedback, PUCCH Format 2/2a/2b for reporting of channel conditions, and PUCCH Format 1 for scheduling requests.

To transmit data in the uplink the mobile terminal has to be assigned an uplink resource for data transmission, on the Physical Uplink Shared Channel (PUSCH). In contrast to a data assignment in the downlink, in the uplink the assignment must always be consecutive in frequency, in order to retain the single carrier property of the uplink as illustrated in FIG. 4. In LTE Rel-10 this restriction may however be relaxed enabling non-contiguous uplink transmissions.

The middle SC-symbol in each slot is used to transmit a reference symbol. If the mobile terminal has been assigned an uplink resource for data transmission and at the same time instance has control information to transmit, it will transmit the control information together with the data on PUSCH.

In order to meet the upcoming IMT-Advanced requirements, 3GPP is currently standardizing LTE Rel-10 (“LTE-Advanced”). One property of Rel-10 is the support of bandwidths larger than 20 MHz while still providing backwards compatibility with Rel-8. This is achieved by aggregating multiple component carriers, each of which can be Rel-8 compatible, to form a larger overall bandwidth to a Rel-10 terminal. Different variants of carrier aggregation are shown in FIGS. 5(a)-5(c). Therein, FIG. 5(a) illustrates contiguous intra-band carrier aggregation, FIG. 5(b) illustrates non-contiguous intra-band carrier aggregation, and FIG. 5(c) illustrates inter-band carrier aggregation.

In essence, each of the component carriers 600 in FIG. 6 is separately processed. For example, hybrid ARQ (HARQ) is operated separately on each component carrier as illustrated in FIG. 6. For the operation of hybrid-ARQ, acknowledgements informing the transmitter on whether the reception of a transport block was successful or not are required. A straightforward way of realizing this is to transmit multiple acknowledgement messages, one per component carrier.

However, transmitting multiple hybrid-ARQ acknowledgement messages, one per component carrier, can in some situations be troublesome. Typically transmissions of multiple PUCCH—one PUCCH per component carrier—destroy the single carrier property of the UL signal, thus requiring higher power backoff. 3GPP defined therefore a new PUCCH format—PUCCH Format 3—that can handle payloads of up to 11 bits for FDD and 21 bits for TDD.

FIG. 7 shows a block diagram of the currently adopted solution. Forward error correction coding (FEC) and scrambling transforms the original uplink control information bits into a sequence of 48 coded bits. In FIG. 1, one time slot is shown. The other 24 coded bits are transmitted with a similar structure in the second slot. Bold lines in FIG. 7 depict a vector of signals, whereas non-bold lines represent scalars. PUCCH Format 3 is transmitted on the uplink primary component carrier. The uplink primary component carrier is linked to the downlink primary component carrier, also referred to as primary cell or PCell. The pair of uplink and downlink primary component carrier is UE specific and configured for each terminal by higher layer signaling.

The bit sequence corresponding to the UL control information is Reed-Muller (RM) encoded (in case of TDD, dual-RM encoded) in step 710, potentially scrambled in step 720, mapped to QPSK symbols in steps 730a-e, and DFT precoded in steps 760a-e. To apply multiplexing of users onto the same time-frequency resources, orthogonal block spreading with an Orthogonal Cover Code (OCC) is applied, indicated by crossed circles.

An OCC is a set of codes which are orthogonal. Thus, two signals encoded with two different codes from an OCC will not interfere with one another. One example of an OCC is a Walsh code, but a number of other OCC:s are known in the art. An OCC may also be referred to as an orthogonal covering code, or an orthogonal spreading code. Throughout this disclosure, the term “orthogonal cover code sequence” will be used to refer to one code, or one orthogonal sequence, from an OCC. For example, in the case of a Walsh code, each row in the Walsh matrix would be one orthogonal cover code sequence. An orthogonal cover code sequence, or orthogonal sequence, may also be referred to as an orthogonal spreading sequence.

In the example shown in FIG. 7, the 24 coded bits are mapped to 12 QPSK symbols, i.e. complex modulation symbols. Thus, the output from the symbol mapping step in each branch 730a-e of FIG. 7 is a vector of 12 complex modulation symbols, as indicated by the bold lines. To mitigate inter-cell interference, the QPSK symbols are cyclically shifted in steps 740a-e prior to mapping to the input bins of the DFT precoder in steps 750a-e. The applied cyclic shift may depend on any of a cell ID, a SC-FDMA symbol number, a slot number, a subframe number, and a frame number.

Finally, an inverse fast fourier transform (IFFT) is performed in step 760a-e. The resulting output is a sequence of SC-FDMA symbols, Symbol 0-Symbol 6. Symbol 1 and Symbol 4 comprise reference signals, RS.

The process shown in FIG. 7 will now be described in a more general way. The block of bits b(0), . . . , b(M_{bit}−1) (in the above example, M_{bit}=48, where 24 bits are transmitted in each time slot) are scrambled with a UE-specific scrambling sequence, resulting in a block of scrambled bits \tilde{b}(0), . . . , \tilde{b}(M_{bit}−1) according to:

\tilde{b}(i)=(b(i)+c(i))mod 2

In the above formula, the scrambling sequence c(i) is defined by section 7.2 of 3GPP TS 36.211 Evolved Universal Terrestrial Radio Access (E-UTRA); Physical channels and modulation V9.1.0. The sequence c(n) of length M_{PN}, where n=0, 1, . . . , M_{PN}−1, is defined by

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2

where N_{C}=1600 and the first m-sequence shall be initialized with x₁(0)=1, x₁(n)=0, n=1, 2, . . . , 30. The initialization of the second m-sequence is denoted by cᵢₙᵢₜ=Σᵢ₌₀³⁰x₂(i)·2ⁱ. The scrambling sequence generator is initialised with:

cᵢₙᵢₜ=(└nₛ/2┘1)·(2N_{ID}^{cell}+1)·2¹⁶+n_{RNTI} at the start of each subframe where n_{RNTI} is the C-RNTI, N_{ID}^{cell} is the physical layer cell identity, and nₛ is the slot number.

The block of scrambled bits \tilde{b}(0), . . . , \tilde{b}(M_{bit}−1) is QPSK modulated as described in Section 7.1 of the above mentioned 3GPP standard, resulting in a block of complex-valued modulation symbols, or complex modulation symbols, d(0), . . . , d(M_{symb}−1) where M_{symb}=M_{bit}/2=2N_{sc}^{RB}. Thus, each complex-valued modulation symbol, or complex modulation symbol, corresponds to two scrambled bits. In the above example, M_{symb}=24, i.e. 12 symbols per slot, and N_{sc}^{RB} represents the resource block size in the frequency domain, expressed as a number of subcarriers. The complex-valued symbols d(0), . . . , d(M_{symb}−1) are block-wise spread with the orthogonal sequence wₙ_{_{oc}}(i) resulting in N_{SF,0}^{PUCCH}+N_{SF,1}^{PUCCH} sets of N_{sc}^{RB} values each according to:

$${y}_{n} ( i ) = \{ \begin{matrix}{w}_{{n}_{∝} , 0} ( \overline{n} ) \cdot d ( i ) & n < {N}_{SF , 0}^{PUCCH} \\ {w}_{{n}_{∝} , 1} ( \overline{n} ) \cdot d ( {N}_{sc}^{RB} + i ) & otherwise\end{matrix} \\ \overline{n} = n mod {N}_{SF , 0}^{PUCCH} \\ n = 0 , … , {N}_{SF , 0}^{PUCCH} + {N}_{SF , 1}^{PUCCH} - 1 \\ i = 0 , 1 , … , {N}_{sc}^{RB} - 1$$

where N_{SF,0}^{PUCCH}=N_{SF,1}^{PUCCH}=5 for both slots in a subframe using normal PUCCH format 3 and N_{SF,0}^{PUCCH}=5, N_{SF,1}^{PUCCH}=4 holds for the first and second slot, respectively, in a subframe using shortened PUCCH format 3. In the above formula, n is the SC-FDMA symbol index. The orthogonal sequences wₙ_{_{oc}}_{,0}(i) and wₙ_{_{oc}}_{,1}(i) are given by Table 1. Resources used for transmission of PUCCH formats 3 are identified by a resource index n_{PUCCH}⁽³⁾ from which the quantities n_{oc,0} and n_{oc,1} are derived according to

n_{oc,0}=ƒ₀(n_{PUCCH}⁽³⁾,nₛ)

n_{oc,1}=ƒ₁(n_{PUCCH}⁽³⁾,nₛ)

Each set of complex-valued symbols is cyclically shifted according to

\tilde{y}ₙ(i)=yₙ((i+n_{cs}^{cell}(nₛ,l))mod N_{sc}^{RB})

where n_{cs}^{cell}(nₛ,l)=Σᵢ₌₀⁷c(8N_{symb}^{UL}·mₛ+8l+i)·2ⁱ, nₛ is the slot number within a radio frame and l is the SC-FDMA symbol number within a slot.

The shifted sets of complex-valued symbols are transform precoded according to:

$$z ( n \cdot {N}_{sc}^{RB} + k ) = \frac{1}{\sqrt{{N}_{sc}^{RB}}} {\sum }_{i = 0}^{{N}_{sc}^{RB} - 1} {\tilde{y}}_{n} ( i ) {e}^{- j \frac{2 π i k}{{N}_{sc}^{RB}}}$$

$$k = 0 , … , {N}_{sc}^{RB} - 1 \\ n = 0 , … , {N}_{SF , 0}^{PUCCH} + {N}_{SF , 1}^{PUCCH} - 1$$

resulting in a block of complex-valued symbols z(0), . . . , z((N_{SF,0}^{PUCCH}+N_{SF,1}^{PUCCH})N_{sc}^{RB}−1).

TABLE 1
The orthogonal sequence wₙ_{_{oc}} (i).

| Sequence | Orthogonal sequence [wₙ_{_{oc}} (0) . . . wₙ_{_{oc}}(N_{SF}^{PUCCH} − 1)] | |
|---|---|---|
| index n_{oc} | N_{SF}^{PUCCH} = 5 | N_{SF}^{PUCCH} = 4 |
| 0 | [1 1 1 1 1] | [+1 +1 +1 +1] |
| 1 | [1 e^{j2π/5} e^{j4π/5} e^{j6π/5} e^{j8π/5}] | [+1 −1 +1 −1] |
| 2 | [1 e^{j4π/5} e^{j8π/5} e^{j2π/5} e^{j6π/5}] | [+1 −1 −1 +1] |
| 3 | [1 e^{j6π/5} e^{j2π/5} e^{j8π/5} e^{j4π/5}] | [+1 +1 −1 −1] |
| 4 | [1 e^{j8π/5} e^{j6π/5} e^{j4π/5} e^{j2π/5}] | — |

In the paper 3GPP R1-106477, “Evaluation of inter-cell interference issues for PUCCH Format 3”, InterDigital, LCC, the performance of PUCCH Format 3 in the presence of a single dominating interferer is presented. It is shown in this paper that the performance severely suffers from such a correlated disturbance. Accordingly, it would be desirable to address this problem.

### ABBREVIATIONS

### ACK Acknowledgement

### ARQ Automatic Repeat Request

### CA Carrier Aggregation

### CIF Carrier Indicator Field

### CAZAC Constant Amplitude Zero Auto Correlation

### CC Component Carrier

### DCI Downlink Control Information

### HARQ Hybrid Automatic Repeat Request

LTE Long term evolution

### MAC Medium Access Control

### MIMO Multiple-Input Multiple-Output

### NACK Non Acknowledgement

### OFDM Orthogonal Frequency Division Multiple Access

OCC Orthogonal cover code

### PCC Primary Component Carrier

### PDCCH Physical Downlink Control CHannel

### PUCCH Physical Uplink Control Channel

### SCC Secondary Component Carrier

### SORTD Spatial Orthogonal Resource Transmit Diversity

### TPC Transmit Power Control

UE User equipment

### SUMMARY

An object of the invention is to provide a mechanism for transmitting uplink control information with improved performance, in particular in the presence of inter-cell interference.

A further object is to provide a mechanism which is also cost- and energy efficient.

In some embodiments, a method for transmitting uplink control information in a cell is provided. The uplink control information is transmitted during a time slot. According to this method, bits corresponding to uplink control information are mapped to complex modulation symbols. The complex modulation symbols are spread in the time slot using a set of orthogonal cover code, OCC, sequences, such that at least two of the complex modulation symbols are spread using different OCC sequences. The uplink control information is then transmitted using said spread complex modulation symbols.

The symbols may be QPSK symbols. The step of spreading may be performed before cyclic shifting or after cyclic shifting. Alternatively, the method may be performed without cyclic shifting at all.

In some embodiments, a method in a receiver for regenerating uplink control information in a cell during a time slot is provided. A sequence of spread complex modulation symbols is despread using a set of orthogonal cover code, OCC, sequences, such that at least two of the spread complex modulation symbols are despread using different OCC sequences. Thereby, a sequence of complex modulation symbols is generated. The complex modulation symbols are then mapped to bits corresponding to uplink control information.

In some embodiments, a transmitting node, e.g. a user equipment or a relay node, configured to transmit uplink control information in a cell during a time slot is provided. The transmitting node comprises a memory, a transceiver and a processor. The processor is configured to map bits corresponding to uplink control information to complex modulation symbols, and to spread the complex modulation symbols in the time slot using a set of orthogonal cover code, OCC, sequences, such that at least two of the complex modulation symbols are spread using different OCC sequences. The transmitter is configured to transmit said uplink control information using said spread complex modulation symbols.

In some embodiments, a receiving node, e.g. an eNodeB, configured to regenerate uplink control information received in a cell during a time slot is provided. The receiving node comprises a memory, a transceiver and a processor. The processor is configured to despread a sequence of spread complex modulation symbols using a set of orthogonal cover code, OCC, sequences, such that at least two of the spread complex modulation symbols are despread using different OCC sequences, thereby generating a sequence of complex modulation symbols, and further configured to map the complex modulation symbols to bits corresponding to uplink control information.

In various embodiments of the invention, different modulation symbols are spread with different OCC sequences, rather than spreading each modulation symbol with the same OCC sequence. This provides an increased randomization effect which reduces the impact of inter-cell interference. By additionally performing the spreading in the complex modulation symbol domain, instead of in the frequency domain after DFT precoding, the single carrier property of the signal is preserved. Preserving the single carrier property reduces the power back-off, i.e. the necessary power margins in the power amplifier and other components, thereby providing a mechanism which is more cost- and energy efficient compared to solutions where the single carrier property is destroyed.

### BRIEF DESCRIPTION OF THE DRAWINGS

FIG. 1 is a schematic diagram illustrating the LTE time-frequency grid.

FIG. 2 is a schematic diagram illustrating the LTE frame structure.

FIG. 3 is a schematic diagram illustrating an LTE subframe.

FIG. 4 is a schematic diagram illustrating uplink transmission.

FIGS. 5A-C are schematic diagrams illustrating carrier aggregation.

FIG. 6 is a schematic diagram showing processing of data flows in LTE.

FIG. 7 is a schematic diagram illustrating transmission of uplink control information according to the prior art.

FIG. 8 is a schematic diagram showing a scenario in a radio communications network.

FIG. 9 is a schematic diagram showing a scenario in a radio communications network.

FIG. 10 is a schematic diagram illustrating processing of data packets in LTE.

FIG. 11 is a schematic diagram illustrating transmission of uplink control information according to the prior art.

FIG. 12 is a schematic diagram illustrating transmission of uplink control information according to an embodiment of the invention.

FIG. 13 is a schematic diagram illustrating transmission of one SC-FDMA symbol according to an embodiment of the invention.

FIG. 14 is a schematic diagram illustrating transmission of one SC-FDMA symbol according to an embodiment of the invention.

FIG. 15 is a schematic diagram illustrating transmission of uplink control information according to an embodiment of the invention.

FIG. 16 is a schematic diagram illustrating transmission of uplink control information according to an embodiment of the invention.

FIG. 17 is a schematic diagram illustrating transmission of uplink control information according to an embodiment of the invention.

FIG. 18 is a flow chart illustrating a method according to an embodiment.

FIG. 19 is a flow chart illustrating a method according to an embodiment.

FIG. 20 is a flow chart illustrating a method according to an embodiment.

FIG. 21 is a flow chart illustrating a method according to an embodiment.

FIG. 22 is a block diagram of a device according to some embodiments.

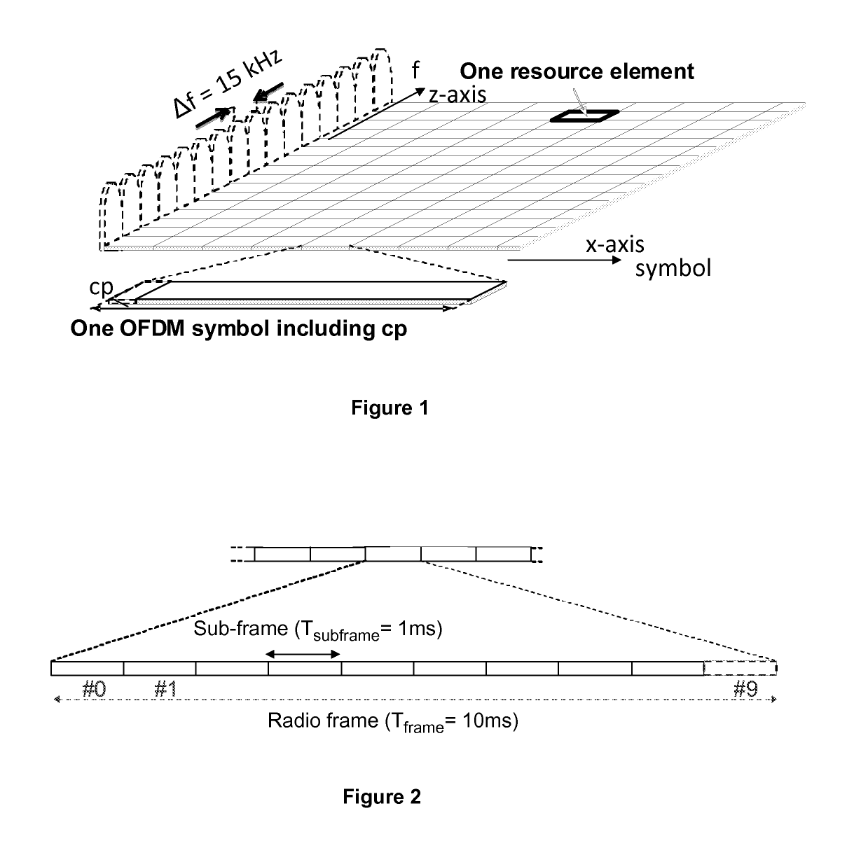

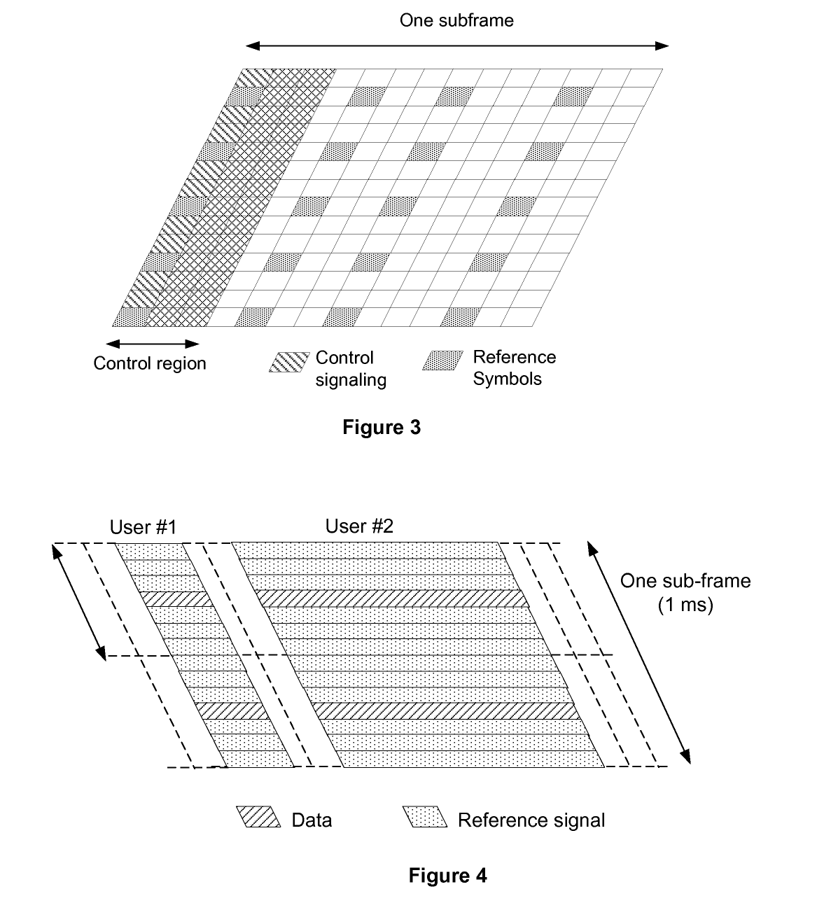

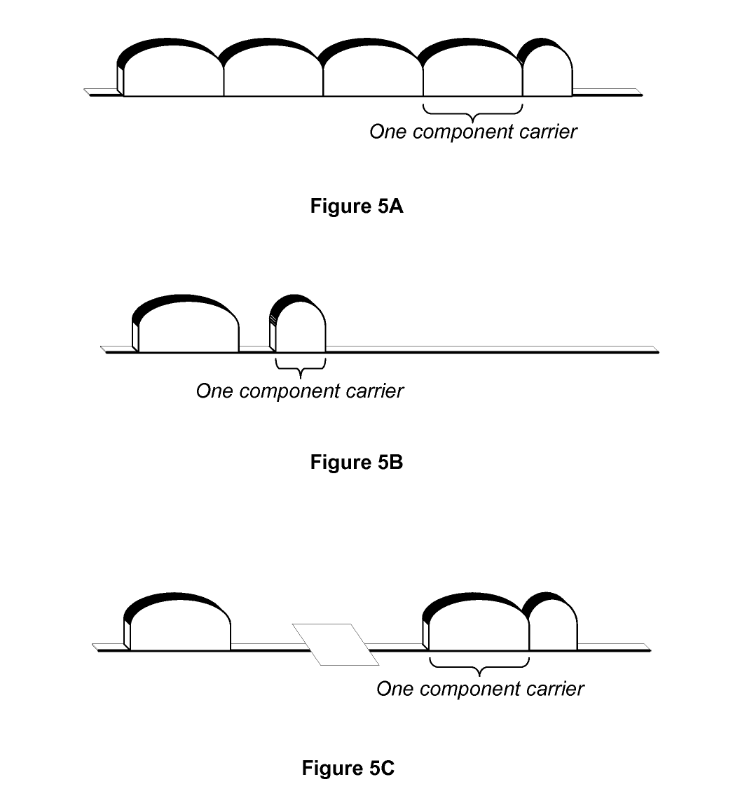

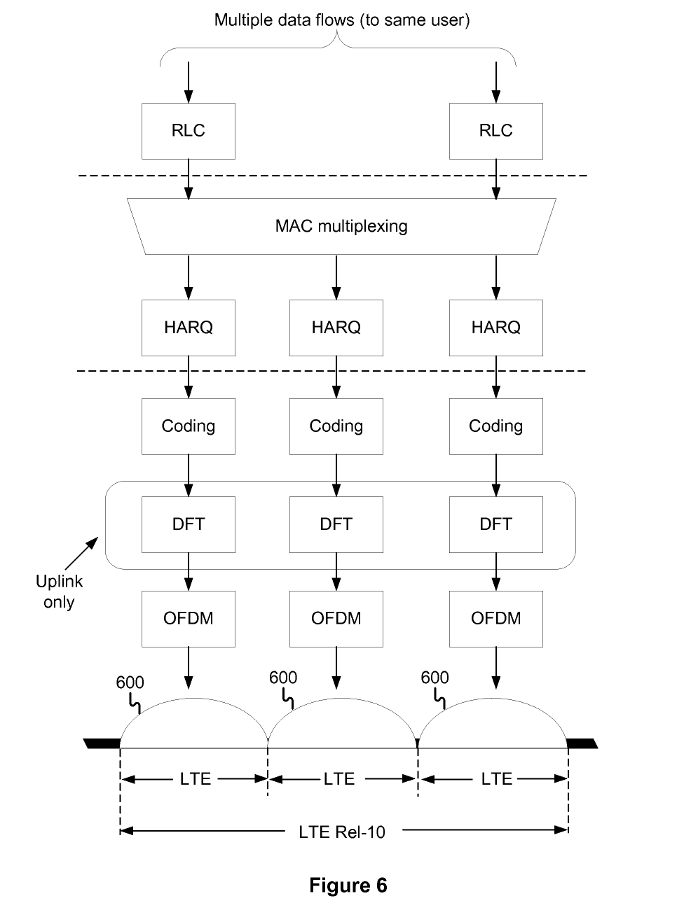

### DETAILED DESCRIPTION

The following detailed description of the example embodiments refers to the accompanying drawings. The same reference numbers in different drawings identify the same or similar elements. Also, the following detailed description does not limit the invention. Instead, the scope of the invention is defined by the appended claims. The following embodiments are discussed, for simplicity, with regard to the terminology and structure of LTE systems. However, the embodiments to be discussed next are not limited to LTE systems but may be applied to other telecommunications systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

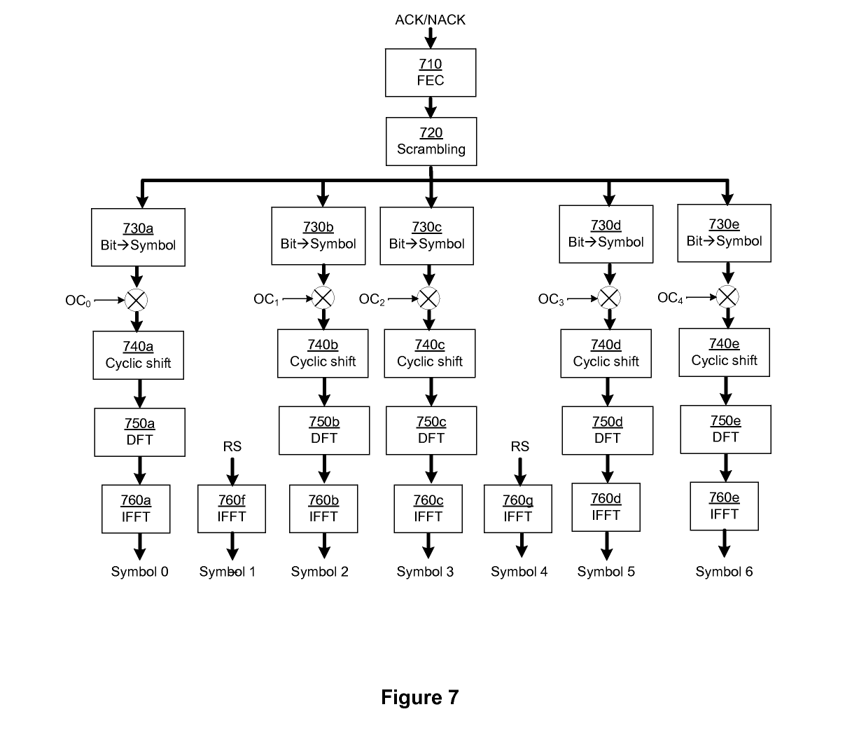

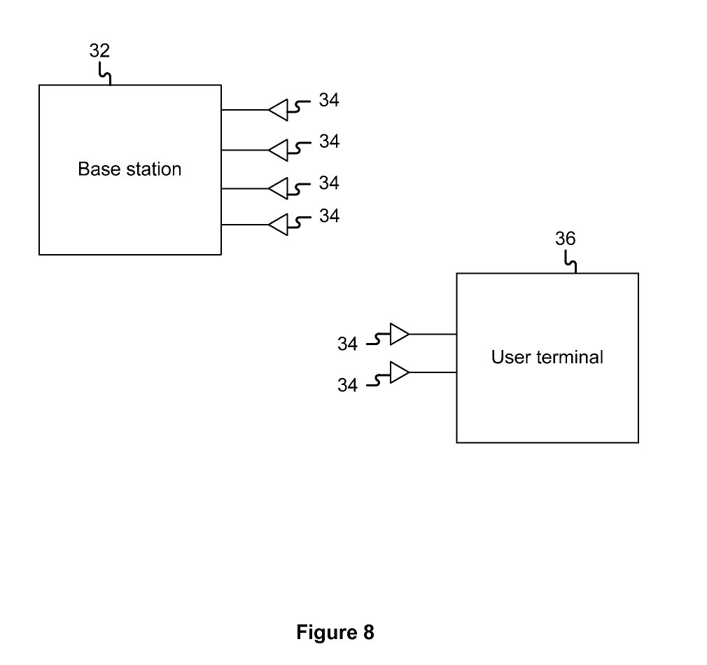

To provide some context for the following example embodiments related to uplink control signaling and reducing interference associated therewith, consider the example radio communication system as shown from two different perspectives in FIGS. 7 and 8, respectively. To increase the transmission rate of the systems, and to provide additional diversity against fading on the radio channels, modern wireless communication systems include transceivers that use multi-antennas (often referred to as a MIMO systems). The multi-antennas may be distributed to the receiver side, to the transmitter side and/or provided at both sides as shown in FIG. 8. More specifically, FIG. 8 shows a base station 32 having four antennas 34 and a user terminal (also referred to herein as “user equipment” or “UE”) 36 having two antennas 34. The number of antennas shown in FIG. 8 is an example only, and is not intended to limit the actual number of antennas used at the base station 32 or at the user terminal 36 in the example embodiments to be discussed below.

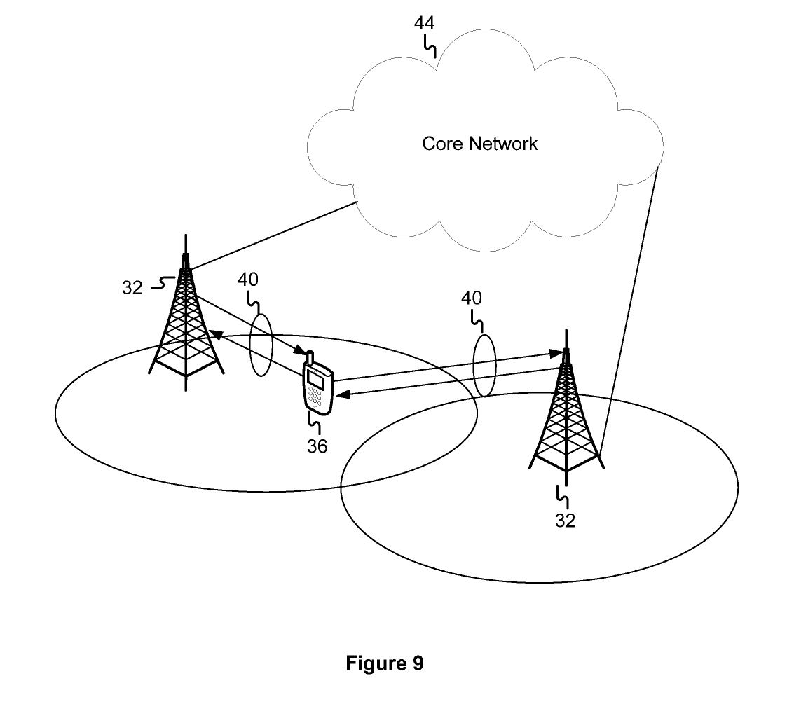

Additionally, the term “base station” is used herein as a generic term. As will be appreciated by those skilled in the art, in the LTE architecture an evolved NodeB (eNodeB) may correspond to the base station, i.e., a base station is a possible implementation of the eNodeB. However, the term “eNodeB” is also broader in some senses than the conventional base station since the eNodeB refers, in general, to a logical node. The term “base station” is used herein as inclusive of a base station, a NodeB, an eNodeB or other nodes specific for other architectures. An eNodeB in an LTE system handles transmission and reception in one or several cells, as shown for example in FIG. 9.

FIG. 9 shows, among other things, two eNodeBs 32 and one user terminal 36. The user terminal 36 uses dedicated channels 40 to communicate with the eNodeB(s) 32, e.g., by transmitting or receiving RLC PDU segments as according to example embodiments described below. The two eNodeBs 32 are connected to a Core Network 44.

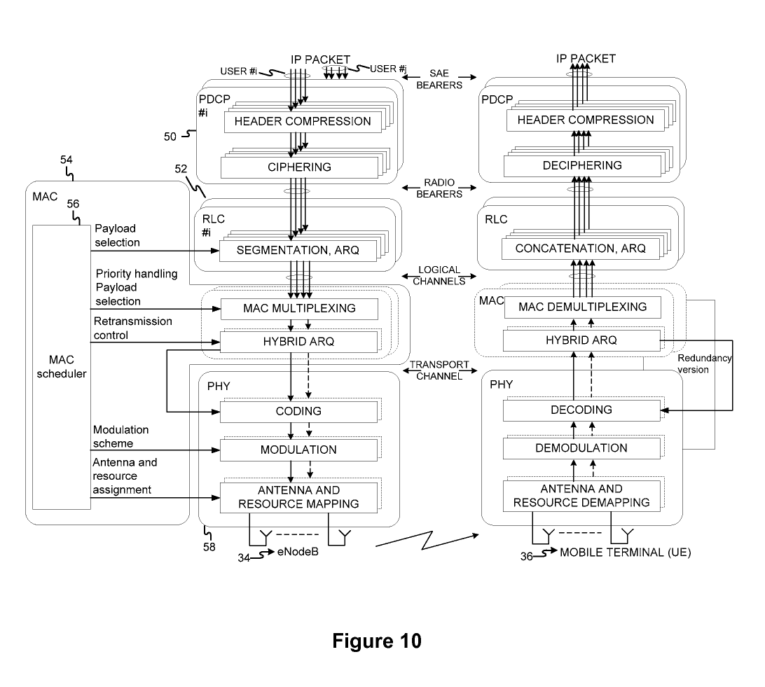

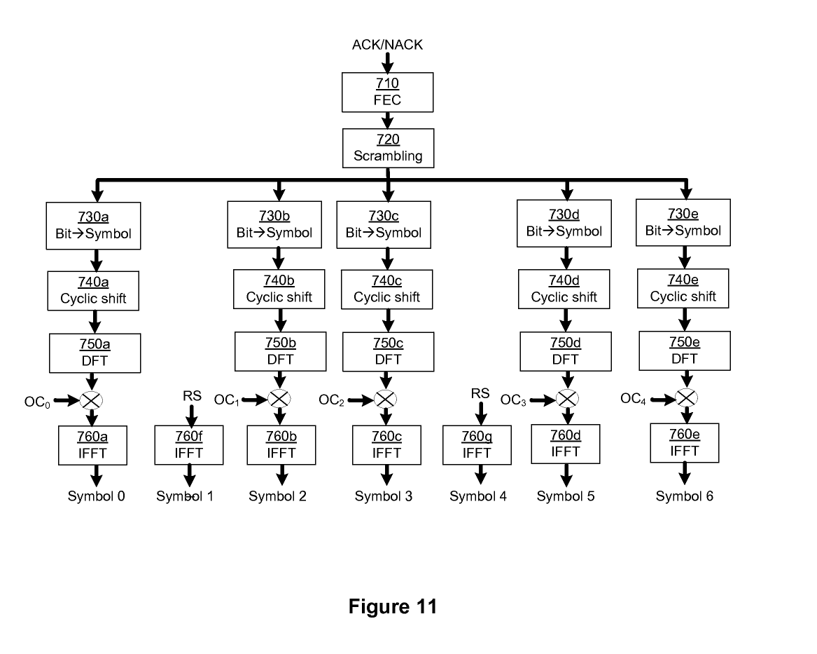

One example LTE architecture for processing data for transmission by an eNodeB 32 to a UE 36 (downlink) is shown in FIG. 10. Therein, data to be transmitted by the eNodeB 32 (e.g., IP packets) to a particular user is first processed by a packet data convergence protocol (PDCP) entity 50 in which the IP headers are (optionally) compressed and ciphering of the data is performed. The radio link control (RLC) entity 52 handles, among other things, segmentation of (and/or concatenation of) the data received from the PDCP entity 50 into protocol data units (PDUs). Additionally, the RLC entity 52 provides a retransmission protocol (ARQ) which monitors sequence number status reports from its counterpart RLC entity in the UE 36 to selectively retransmit PDUs as requested. The medium access control (MAC) entity 54 is responsible for uplink and downlink scheduling via scheduler 56, as well as the hybrid-ARQ processes discussed above. A physical (PHY) layer entity 58 takes care of coding, modulation, and multi-antenna mapping, among other things. Each entity shown in FIG. 10 provides outputs to, and receives inputs from, their adjacent entities by way of bearers or channels as shown. The reverse of these processes are provided for the UE 36 as shown in FIG. 10 for the received data, and the UE 36 also has similar transmit chain elements as the eNB 34 for transmitting on the uplink toward the eNB 32, as will be described in more detail below particularly with respect to uplink control signaling.

Having described some example LTE devices in which aspects of uplink control signal interference mitigation according to example embodiments can be implemented, the discussion now returns to consideration of uplink control signaling in the context of carrier aggregation. As mentioned above, in the paper 3GPP R1-106477, “Evaluation of inter-cell interference issues for PUCCH Format 3”, InterDigital, LCC, the performance of PUCCH Format 3 in the presence of a single dominating interferer is presented and is shown to have a performance which severely suffers from such a correlated disturbance.

One possible solution to address this problem is to apply the OCC per subcarrier as shown in FIG. 11. Therein, bold lines depict a vector of signals, whereas non-bold lines represent scalars, i.e., OCC is applied per subcarrier. That is to say, a different OCC sequence is applied to each subcarrier. Compare with FIG. 7, where the OCC is a non-bold line, i.e. a scalar value is applied. However, the solution of applying OCC per subcarrier per FIG. 11 destroys the single carrier property and higher power backoff is required.

Thus, according to example embodiments, a randomization effect can instead be achieved by applying an OCC per complex-valued symbol, or complex modulation symbol. In contrast to block spreading—where all complex modulation symbols corresponding to one SC-FDMA symbol are spread by the same sequence—each complex modulation symbol is spread with an individual OCC sequence. In contrast to the solution described above with respect to FIG. 11, the solution proposed in these example embodiments does not destroy the single carrier property since the transmission structure after precoding is left unmodified.

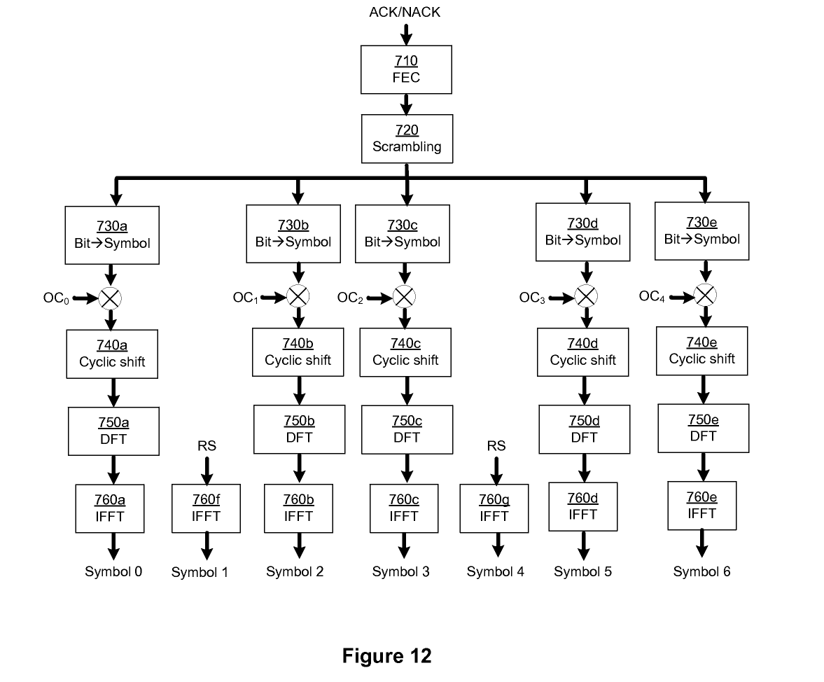

Thus, according to example embodiments, to mitigate inter-cell interference it is proposed to apply OCC—which is needed to multiplex users—in the complex modulation symbol domain rather than in frequency domain (subcarriers) or SC-FDMA symbol domain (a.k.a. DFTS-OFDM symbol, block spreading). A block diagram of this method according to an example embodiment is provided in FIG. 12. Therein, it can be seen that the OCC (OC₀-OC₄) is applied in the complex modulation symbol domain prior to cyclic shifting, one slot being shown. Bold lines depict a vector of signals whereas non-bold lines represent scalars, i.e. an individual OCC sequence is applied per complex modulation symbol (note bold lines for OC₀-OC₄ in FIG. 12 versus non-bolded lines for OC₀-OC₄ in FIG. 7).

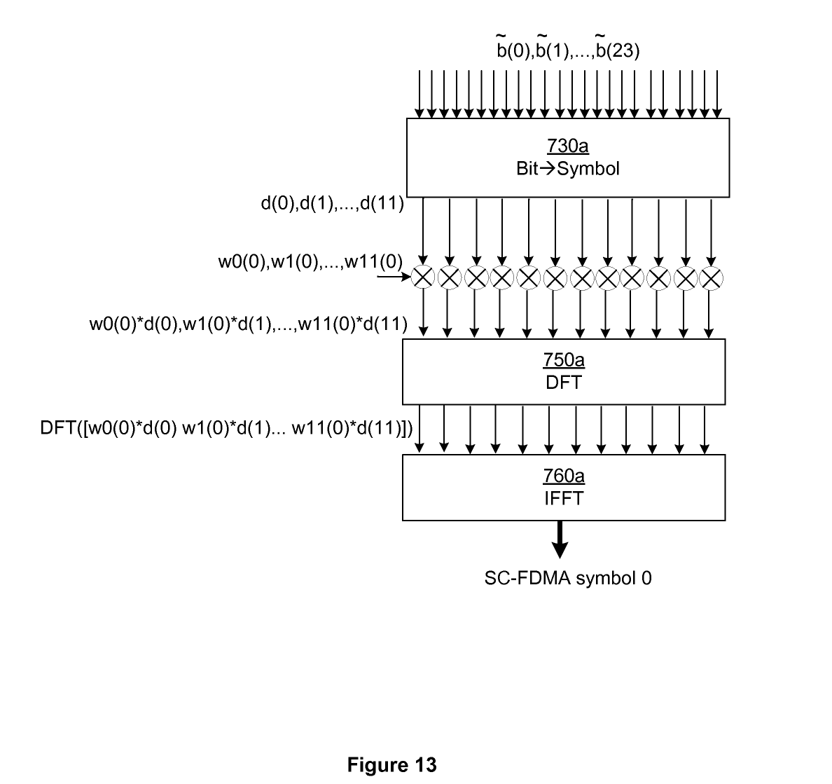

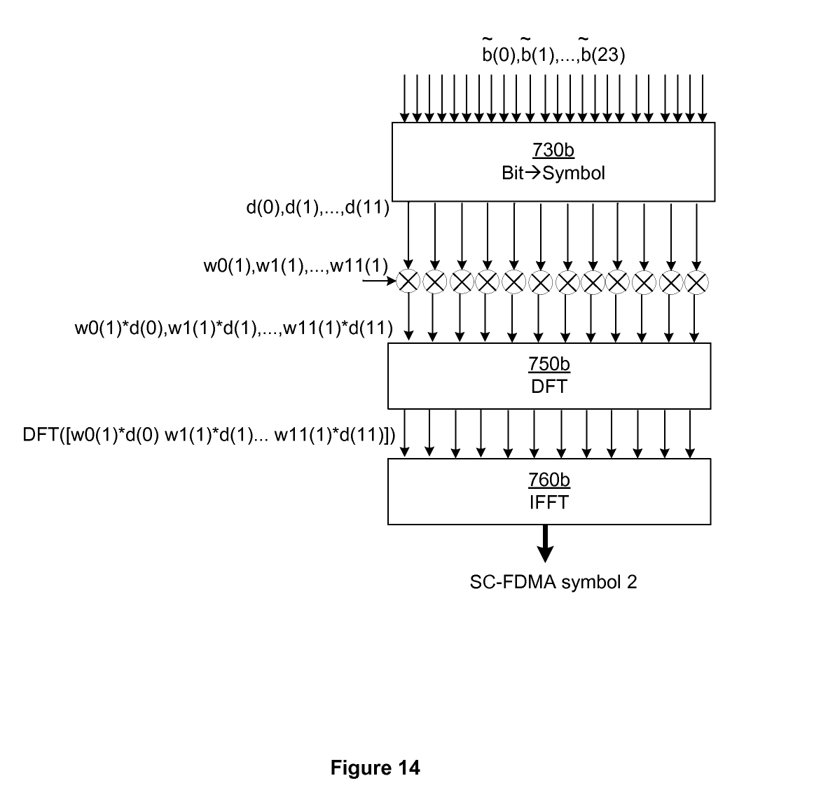

FIGS. 13 and 14 show a specific example the procedure of FIG. 12 in more detail, in order to facilitate understanding of the spreading operation. FIG. 13 is a detailed diagram of steps 730a, 750a, and 760a from FIG. 12, which produce SC-FDMA symbol 0, and FIG. 14 is a detailed diagram of steps 730b, 750b, and 760b, which produce SC-FDMA symbol 2 (recall that SC-FDMA symbol 1 comprises a reference symbol). The cyclic shift 740a and 740b is not shown in FIGS. 13 and 14; as will be further explained below, cyclic shifting may be omitted.

Turning now to FIG. 13, in step 730a, a sequence of bits \tilde{b}(0), \tilde{b}(1) . . . , \tilde{b}(23), corresponding to uplink control information transmitted in one time slot, are mapped to complex modulation symbols. The bits may have been encoded, e.g. using forward error correction (FEC) coding, and/or scrambled prior to step 730a. In the present example, the 24 bits are mapped to 12 complex modulation symbols d(0), d(1), . . . , d(11) using QPSK modulation.

Next, an orthogonal cover code sequence is applied to each complex modulation symbol, as indicated by the crossed circles in FIG. 13. This may be done by selecting a sequence index, i.e. an index indicating one of the sequences of the OCC, for each symbol. In the present example, index 0 is selected for d0, index 1 is selected for d1 and so forth. Thus, orthogonal sequence w₀(0), i.e. the first code element of sequence w₀, is applied to symbol d(0). Orthogonal sequence w₁(0), i.e. the first code element of sequence w₁, is applied to symbol d(1), and so forth. We assume here that the orthogonal sequences of length 5, shown in Table 1 above, are used, so that w₀=[1 1 1 1 1], and w₁=[1 e^{j2π/5} e^{j4π/5} e^{j6π/5} e^{j8π/5}]. In other words, symbol d(0) is multiplied by 1 in the first SC-FDMA symbol, and d(1) is also multiplied by 1 in the first SC-FDMA symbol.

It should be noted that in each branch a-e shown in FIG. 12, each symbol d(i) will be multiplied by a different element from the OCC sequence selected for the symbol. This will result in spreading the complex modulation symbols across the time slot. Consider FIG. 14, which shows the same procedure as FIG. 13, but for SC-FDMA symbol 2. The same bits \tilde{b}(0), \tilde{b}(1) . . . , \tilde{b}(23) are input to step 730b, and the same complex modulation symbols d(0), . . . , d(11) are produced. However, in the multiplication step, each symbol is multiplied with the second code element of the orthogonal sequence selected for the respective symbol. Thus, d(0) is multiplied by w₀(1)=1, d(1) is multiplied by w₁(1)=e^{j2π/5} and so forth.

The reason for using a length-5 OCC is that the complex modulation symbols will be spread over five SC-FDMA symbols (symbols 0, 2, 3, 5, and 6).

In some embodiments, the code elements may be applied in a different order. For instance, the code elements could be applied in the reverse order such that the last code element of each sequence is applied to the complex modulation symbols corresponding to SC-FDMA symbol 0, the next-to-last element of each sequence is applied to the complex modulation symbols corresponding to SC-FDMA symbol 2, and so forth. It is emphasized that although the OCC sequences are denoted w₀ . . . w₁₁, this does not mean that 11 different sequences are used. In the present example, the OCC is of length 5, which means that only five different sequences are available. Thus, each one of the 11 sequences which are applied to d(0), . . . , d(11) is selected out of the available set of five sequences in the OCC set. That is to say, the index i in wᵢ, as used in FIGS. 13 and 14, does not directly correspond to the orthogonal sequence index.

As pointed out above, when a length-5 OCC is used to spread 12 symbols, as in the present example, some of the symbols will obviously be spread using the same sequence. However, the likelihood that a user equipment in a neighboring cell would select the exact same combination of 12 sequence indices is very low, compared to the prior art solution of FIG. 7 where the same OCC sequence is used for all symbols. Thus, the risk of strong inter-cell interference is reduced.

Note that this example has been simplified for easier understanding of the spreading procedure. It has been assumed in the above example that sequence w₀ is applied to d0, i.e. sequence index 0 is selected for d0, and that sequence w₁ is applied to d1, et cetera. As will be explained below, this is not necessarily the case. On the contrary, various mechanisms are possible for selecting which sequence to use for each symbol, including using a pseudo-random function based on slot number and/or symbol number.

It should be appreciated that the number of bits, the modulation scheme, and the OCC may vary within the scope of this and other embodiments disclosed herein. This example assumes 24 bits per slot, QPSK modulation and the OCC of Table 1, which are used within the current LTE standard. However, the concepts described here are not dependent on these particular settings. Thus, it is possible to use another number of bits per slot, and/or another modulation scheme (in particular a higher-order scheme but also BPSK), and/or another orthogonal cover code, provided that the length of the OCC matches the number of SC-FDMA symbols.

That is, the spreading operation according to the example embodiment of FIGS. 12, 13 and 14 can be described by:

$${y}_{n} ( i ) = \{ \begin{matrix}{w}_{{n}_{∝} , 0} ( \overline{n} ) \cdot d ( i ) & n < {N}_{SF , 0}^{PUCCH} \\ {w}_{{n}_{∝} , 1} ( \overline{n} ) \cdot d ( {N}_{sc}^{RB} + i ) & otherwise\end{matrix} \\ \overline{n} = n mod {N}_{SF , 0}^{PUCCH} \\ n = 0 , … , {N}_{SF , 0}^{PUCCH} + {N}_{SF , 1}^{PUCCH} - 1 \\ i = 0 , 1 , … , {N}_{sc}^{RB} - 1$$

The OCC resource indices n_{oc,0} and n_{oc,1} shall vary for each of the complex-valued symbols, or complex modulation symbols, d(0), . . . , d(M_{symb}−1) or, equivalently, with the slot number nₛ and symbol number i.

In order to mitigate inter-cell interference according to an example embodiment, the OCC resource indices may also be a function of any one or more of the following parameters:
a cell ID,
PUCCH format 3 resource index given by RRC, PUCCH format 3 resource index given by a DCI format, PUCCH format 3 resource index given by an implicit rule or a combination of the previous mentioned PUCCH format 3 resource indices,
a slot number,
a subframe number,
RNTI,
a frame number.
   Non-limiting examples of functions to derive the OCC resource indices are

n_{oc,0}=ƒ₀(n_{PUCCH}⁽³⁾,n_{oc}^{cell}(nₛ,i))

n_{oc,1}=ƒ₁(n_{PUCCH}⁽³⁾,n_{oc}^{cell}(nₛ,i))

where the cell-specific OCC resource index, or cell-specific OCC sequence index, n_{oc}^{cell}(nₛ,i) varies with the slot number nₛ and symbol number i.

A non-limiting example method to compute the cell-specific OCC resource index, or cell-specific OCC sequence index, according to an example embodiment is:

n_{oc}^{cell}(nₛ,i)=Σₖ₌₀⁷c(8N_{sc}^{RB}·nₛ+8i+k)·2^{k}

where N_{sc}^{RB}=12 and the pseudo-random sequence c(i) is defined by section 7.2 3GPP TS 36.211 Evolved Universal Terrestrial Radio Access (E-UTRA); Physical channels and modulation V9.1.0. The pseudo-random sequence generator can be initialized with a value related to the primary cell's cell ID at the beginning of each radio frame. One nonlimiting method to initialize the pseudo-random sequence generator is to use cᵢₙᵢₜ=N_{ID}^{cell} corresponding to the primary cell, or based on the cell identity. A second nonlimiting example method is to initialize the pseudo-random sequence generator at the beginning of each subframe with a value related to the primary cell ID and the slot number nₛ. Nonlimiting examples of the initialization values include cᵢₙᵢₜ=└nₛ/2┘·2⁹+N_{ID}^{cell} or cᵢₙᵢₜ=(└nₛ/2┘+1)·(2N_{ID}^{cell}+1).

One nonlimiting example of a function ƒ₀ to derive the OCC resource index, or sequence index, from the format 3 PUCCH resource index n_{PUCCH}⁽³⁾ and the cell-specific OCC resource index, or cell-specific OCC sequence index, n_{oc}^{cell}(nₛ,i) for the first slot is:

n_{oc,0}=ƒ₀(n_{PUCCH}⁽³⁾,n_{oc}^{cell}(nₛ,i))=(n_{PUCCH}⁽³⁾+n_{oc}^{cell}(nₛ,i))mod N_{SF,1}^{PUCCH}

A second nonlimiting example of function ƒ₀ is to replace N_{SF,1}^{PUCCH} in the above with N_{SF,0}^{PUCCH}.

One nonlimiting example of a function ƒ₁ to derive the OCC resource index, or sequence index, from the format 3 PUCCH resource index n_{PUCCH}⁽³⁾ and the cell-specific OCC resource index, or cell-specific OCC sequence index, n_{oc}^{cell}(nₛ,i) for the second slot is to use the same function ƒ₀ for the first slot.

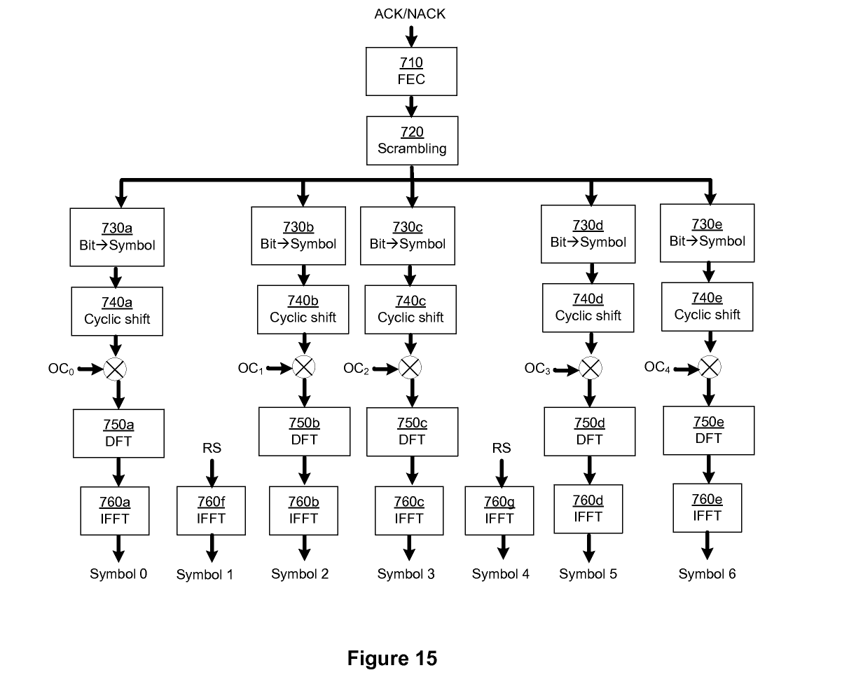

An alternative example embodiment involves interchanging the position of OCC spreading and cyclic shifting as shown in FIG. 15. Thus, in the embodiment of FIG. 15, the OCC is applied in the symbol domain after cyclic shifting on a per symbol basis rather than a per SC-FDMA symbol basis. Once again, bold lines in FIG. 15 depict a vector of signals whereas non-bold lines represent scalars.

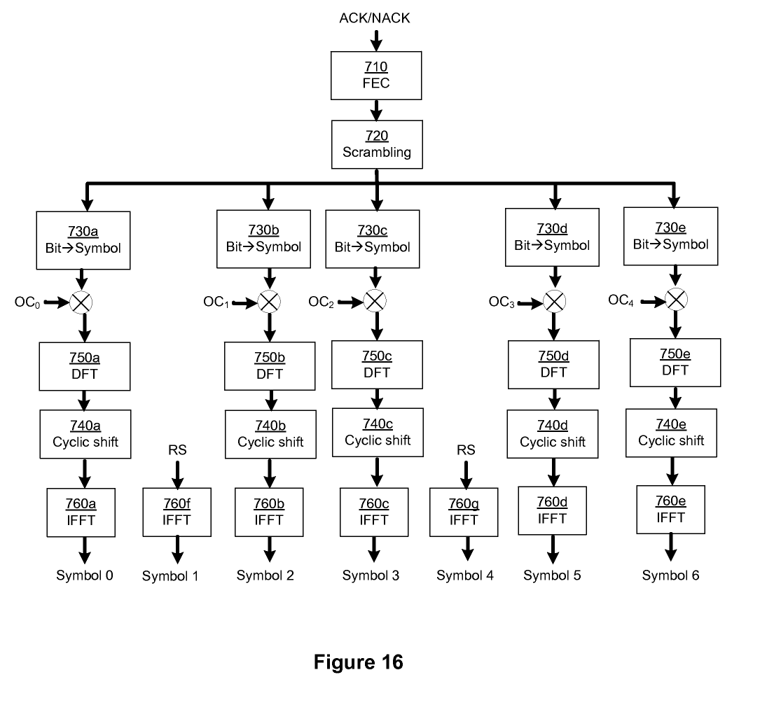

In yet another alternative example embodiment, the cyclic shifting is moved after the DFT, i.e. into the subcarrier domain, as shown in FIG. 16. Once again, bold lines in FIG. 16 depict a vector of signals whereas non-bold lines represent scalars. Thus the OCC is again applied in the symbol domain, i.e., per complex modulation symbol rather than per SC-FDMA symbol, and an individual OCC sequence is applied to each complex modulation symbol.

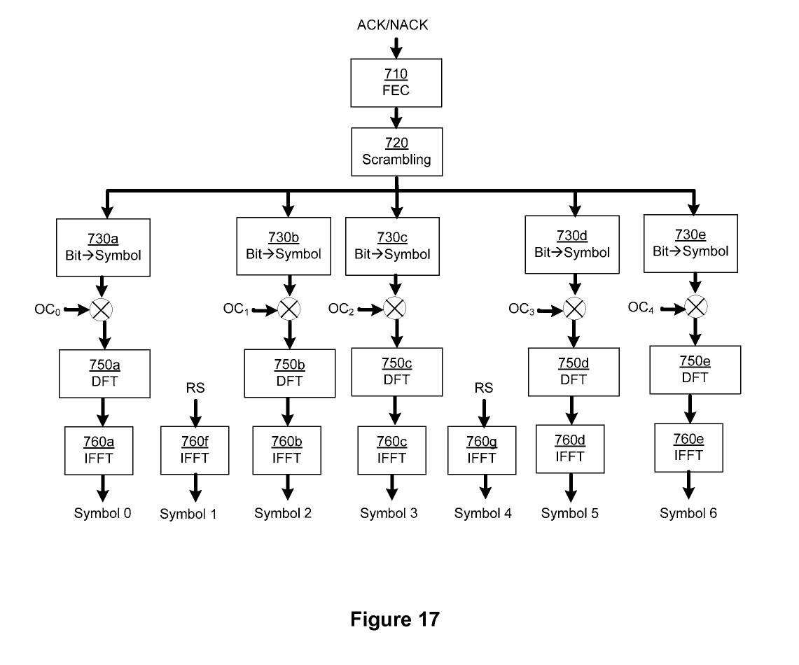

In yet another alternative shown in FIG. 17, the cyclic shifting is removed since already the symbol dependent OCC provides sufficient inter-cell interference mitigation. Once again, bold lines in FIG. 17 depict a vector of signals whereas non-bold lines represent scalars. Thus the OCC is again applied in the symbol domain, i.e., per complex modulation symbol rather than per SC-FDMA symbol, and an individual OCC sequence is applied to each complex modulation symbol.

3GPP currently discusses various transmit diversity schemes for PUCCH. One possible classification of the discussed schemes is to group them into schemes requiring a single PUCCH resource (FSTD, Alamouti, etc) and schemes requiring multiple PUCCH resources (SORTD). The example embodiments described above are directly applicable to the first group since here only one PUCCH resource is used.

For SORTD however multiple—typically two—PUCCH resources are needed. If multiple PUCCH Format 3 resource indices n_{PUCCH}⁽³⁾ are provided above embodiments are directly applicable to each transmission branch transmitting on one of the resources n_{PUCCH}^{(3,p)}. The newly introduced index p is the (virtual) antenna port number. Generalizing above example formulas to multiple antenna ports results in:

OCC sequence number for first slot, antenna port p

n_{oc,0}^{(p)}=ƒ₀(n_{PUCCH}^{(3,p)},n_{oc}^{cell}(nₛ,i))=(n_{PUCCH}^{(3,p)}+n_{oc}^{cell}(nₛ,i))mod N_{SF,1}^{PUCCH} or

n_{oc,0}^{(p)}=ƒ₀(n_{PUCCH}^{(3,p)},n_{oc}^{cell}(nₛ,i))=(n_{PUCCH}^{(3,p)}+n_{oc}^{cell}(nₛ,i))mod N_{SF,0}^{PUCCH}

OCC sequence number for second slot, antenna port p

n_{oc,1}^{(p)}=ƒ₁(n_{PUCCH}^{(3,p)},n_{oc}^{cell}(nₛ,i))=(n_{PUCCH}^{(3,p)}+n_{oc}^{cell}(nₛ,i))mod N_{SF,1}^{PUCCH}

If only one resource n_{PUCCH}^{(3,p)}, e.g. n_{PUCCH}^{(3,0)} for the first antenna port is provided an implicit mapping scheme is used to derive the remaining resource indices n_{PUCCH}^{(3,p)}, p≧1 and above formulas for transmit diversity can be applied.

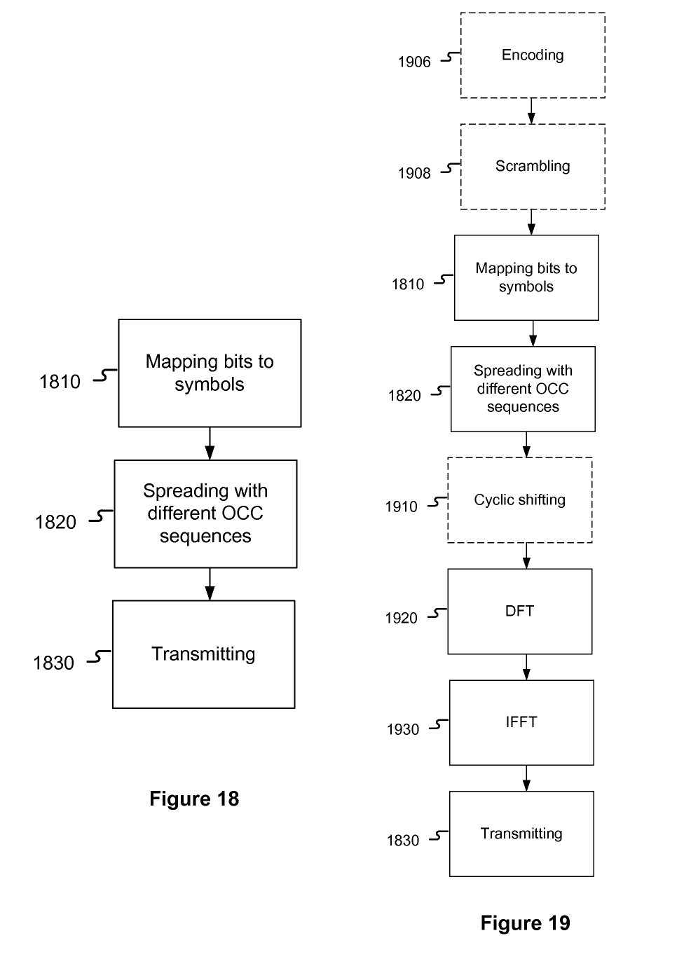

An example method for transmitting uplink control information in a cell during a time slot according to an embodiment will now be described, with reference to the flow chart in FIG. 18. The example method is executed in a transmitting node, e.g. a user equipment or a relay node.

In step 1810, bits corresponding to uplink control information are mapped to complex modulation symbols. As explained above, any modulation scheme may be used, e.g. QPSK modulation. Furthermore, the expression “complex modulation symbols” also encompasses real symbols, e.g. BPSK symbols. The bits may have been encoded and/or scrambled before step 1810.

The complex modulation symbols are then spread in the time slot in step 1820, using a set of orthogonal cover code, OCC, sequences, such that at least two of the complex modulation symbols are spread using different OCC sequences. The application of OCC sequences to symbols has been explained in detail above in connection with FIGS. 13-14.

The OCC sequence, i.e. the sequence index, to use for spreading a symbol may be selected in various different ways within the scope of this embodiment.

In some variants, the step of spreading the complex modulation symbols comprises selecting an OCC sequence for each complex modulation symbol based on a symbol number associated with the complex modulation symbol. The selection of an OCC sequence for each complex modulation symbol is further based on one or more of: cell identity, PUCCH format 3 resource index, slot number, subframe number, RNTI, or frame number. As a particular example, the selection of an OCC sequence for each complex modulation symbol may comprise calculating an OCC sequence index based on a function of the slot number, the symbol number, and a random or pseudo-random value. The random or pseudo-random value may be generated from a pseudo-random sequence, which has been initialized with a value related to the cell identity. It should be noted that any of the example functions for deriving the OCC resource indices that have been described above may be used for selecting the OCC sequence, or OCC sequence index.

The uplink control information is transmitted using said spread complex modulation symbols in step 1830. In some variants, a discrete fourier transform step and an IFFT step may be performed before transmission. Furthermore, cyclic shifting may be performed in some variants. The cyclic shifting may be done at various different stages as described in connection with FIGS. 12, 15 and 16. In particular, cyclic shifting may be applied to the output values of the DFT precoding operation. Alternatively, the complex modulation symbols may be cyclically shifted, before or after spreading.

A further example embodiment will now be described with reference to the flow chart in FIG. 19. This embodiment is based on the one described above in connection with FIG. 18.

Bits corresponding to uplink control information are encoded in a step 1906 and/or scrambled in a step 1908. In step 1810, the bits are mapped to complex modulation symbols, e.g. using QPSK modulation. As mentioned above, the expression “complex modulation symbols” also encompasses real symbols, e.g. BPSK symbols.

In step 1820, the complex modulation symbols are spread using an OCC, such that at least two of the complex modulation symbols are spread using different OCC sequences, as has been explained above.

In step 1910, the spread complex modulation symbols are cyclically shifted. However, in some variants this step may be omitted.

A DFT operation is then performed in step 1920. It is pointed out that the DFT precoding is applied per set of complex modulation symbols, where each set comprises the complex modulation symbols which correspond to one Single Carrier-Frequency Division Multiple Access, SC-FDMA, symbol. This is shown clearly in FIGS. 13 and 14.

An IFFT operation and optionally a cyclic prefix insertion is performed in step 1930. Finally, the resulting SC-FDMA symbols are transmitted in step 1830.

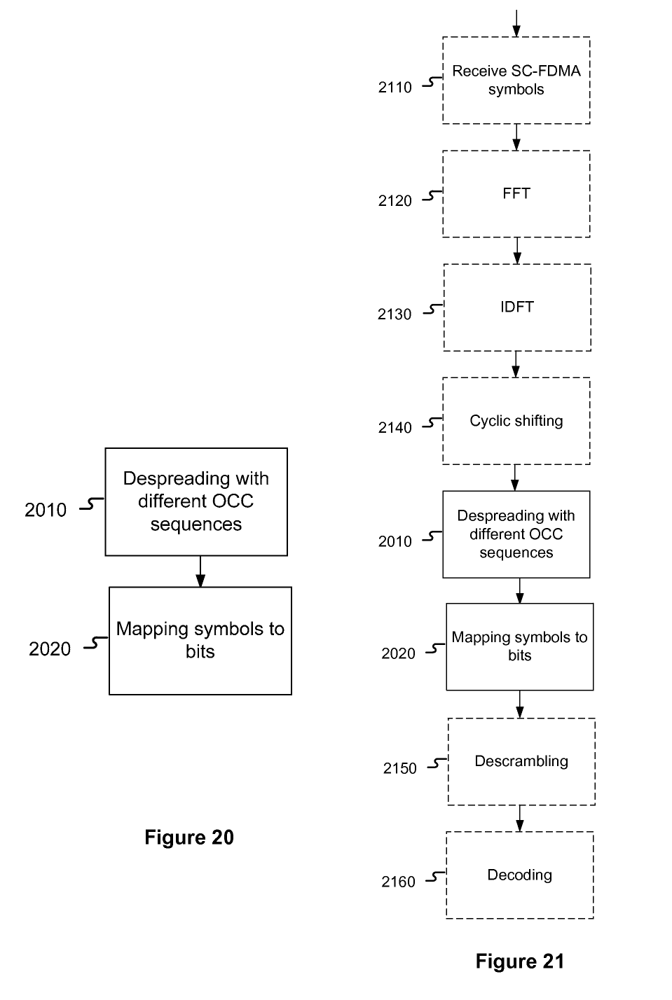

An example embodiment in a receiver, for regenerating uplink control information received in a cell during a time slot, will now be described with reference to the flow chart in FIG. 20. The receiver may be e.g. an eNodeB, or a relay node. The steps of this example method are essentially the reverse of the steps described in connection with FIGS. 18-19.

Thus, a sequence of spread complex modulation symbols are despread in step 2010 using a set of orthogonal cover code, OCC, sequences, such that at least two of the spread complex modulation symbols are despread using different OCC sequences, thereby generating a sequence of complex modulation symbols.

The complex modulation symbols are then mapped to bits corresponding to uplink control information in step 2020.

Obviously, the receiver must select the same OCC sequence for each symbol in the despreading step that were used for spreading by the transmitter. This may be ensured by initializing a pseudo-random sequence generator by the same value (e.g. a value related to the cell identity). Furthermore, transmitter and receiver generally share a common understanding of the timing, and may exchange additional signaling indicating e.g. the PUCCH format 3 resource index.

Another example embodiment will now be described with reference to the flow chart in FIG. 21. This embodiment is based on the one described with reference to FIG. 20 above.

In step 2110, a sequence of Single Carrier Frequency Division Multiple Access, SC-FDMA, symbols is received.

A fast fourier transform is performed on the SC-FDMA symbols in step 2120, followed by an inverse discrete fourier transform operation in step 2130. This generates a sequence of spread complex modulation symbols. An equalization stage may be implemented between the fast Fourier transform and the inverse discrete Fourier transform operation.

In step 2140, cyclic shifting of the bits is performed. This step may be omitted or performed at various other stages of the process as explained above.

Steps 2010 and 2020 are the same as described in connection with FIG. 20 above.

In steps 2150 and 2160, the bits are descrambled and decoded, depending on the processing that was performed at the transmitting side.

The aforedescribed example embodiments have been demonstrated in the context of PUCCH for normal subframes and normal cyclic prefix. However, the invention is also applicable for extended cyclic prefix and shortened PUCCH Format 3 (PUCCH format used for example in some cases where cell specific SRS is configured), or for transmissions on uplink channels other than PUCCH. Moreover, even though outlined in the context of DL hybrid-ARQ information, this present invention is also applicable to all kinds of transmission schemes that use precoding and where OCC is applied to multiplex users. One typical example would be the transmission of Channel State Information (CSI) using such a transmission scheme, e.g. (modified) PUCCH Format 3. It should further be noted that the present invention does not require the use of carrier aggregation.

Among other advantages, example embodiments enable inter-cell interference mitigation without destroying the single-carrier property. Single carrier signals have a low amplitude fluctuation and thus require only low power backoff in the transmitter. Being able to transmit without/low power backoff enables higher output powers which increase coverage.

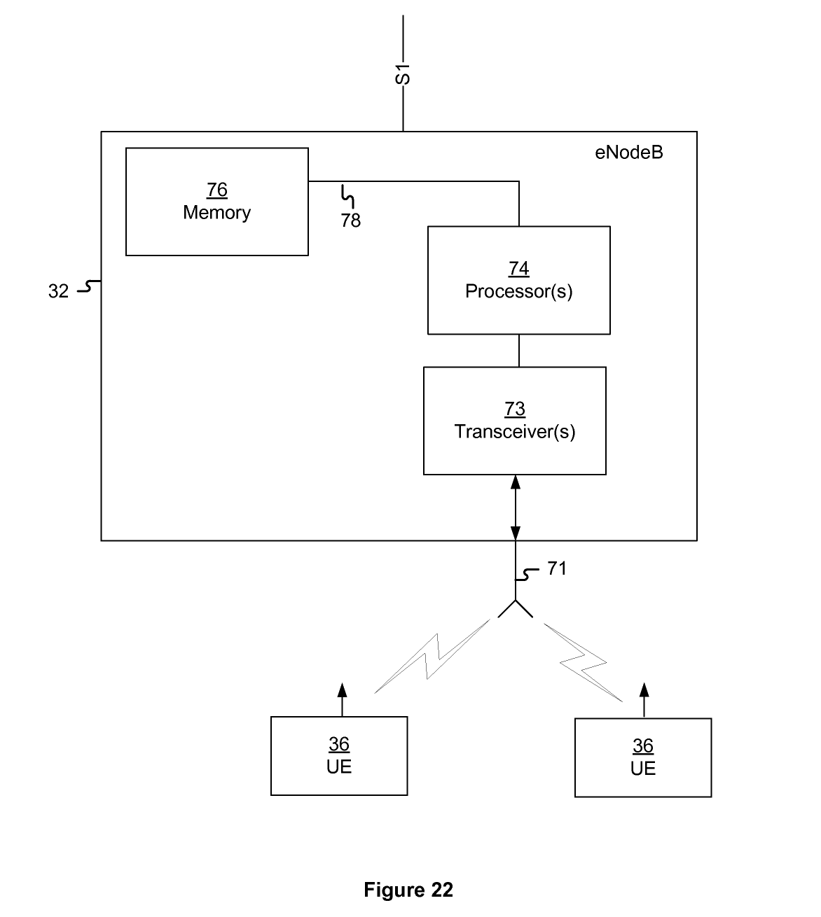

An example base station 32, e.g., an eNodeB, which is configured to receive uplink control signals as described above is generically illustrated in FIG. 22. Therein, the eNodeB 32 includes one or more antennas 71 connected to processor(s) 74 via transceiver(s) 73. The processor 74 is configured to analyze and process signals received over an air interface via the antennas 71, as well as those signals received from core network node (e.g., access gateway) via, e.g., an interface. The processor(s) 74 may also be connected to one or more memory device(s) 76 via a bus 78. Further units or functions, not shown, for performing various operations as encoding, decoding, modulation, demodulation, encryption, scrambling, precoding, etc. may optionally be implemented not only as electrical components but also in software or a combination of these two possibilities as would be appreciated by those skilled in the art to enable the transceiver(s) 72 and processor(s) 74 to process uplink and downlink signals. A similar, generic structure, e.g., including a memory device, processor(s) and a transceiver, can be used (among other things) to implement communication nodes such as UEs 36 to transmit uplink control signals in the manner described above.

The above-described example embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for transmitting uplink control information in a cell during a time slot, the method comprising the steps of:
mapping bits corresponding to uplink control information to complex modulation symbols;
spreading the complex modulation symbols in the time slot using a set of orthogonal cover code, OCC, sequences, such that at least two of the complex modulation symbols are spread using different OCC sequences; and
transmitting said uplink control information using said spread complex modulation symbols.

2. The method of claim 1, wherein the step of spreading the complex modulation symbols comprises selecting an OCC sequence for each complex modulation symbol based on a symbol number associated with the complex modulation symbol.

3. The method of claim 2, wherein the selection of an OCC sequence for each complex modulation symbol is further based on one or more of: cell identity, PUCCH format 3 resource index, slot number, subframe number, RNTI, or frame number.

4. The method of claim 3, wherein the selection of an OCC sequence for each complex modulation symbol comprises calculating an OCC sequence index based on a function of the slot number, the symbol number, and a random or pseudo-random value.

5. The method of claim 4, wherein the random or pseudo-random value is generated from a pseudo-random sequence, which has been initialized with a value related to the cell identity.

6. The method of claim 1, wherein further comprising DFT precoding the spread complex modulation symbols, wherein DFT precoding is applied per set of complex modulation symbols, where each set comprises the complex modulation symbols which correspond to one Single Carrier-Frequency Division Multiple Access, SC-FDMA, symbol.

7. The method of claim 6, further comprising performing cyclic shifting of the output values of the DFT precoding operation.

8. The method of claim 1, further comprising performing cyclic shifting of the complex modulation symbols.

9. The method of claim 8, wherein the cyclic shifting is performed before spreading the complex modulation symbols.

10. The method of claim 8, wherein the cyclic shifting is performed on the spread complex modulation symbols.

11. The method of claim 1, further comprising encoding and/or scrambling the bits.

12. A method in a receiver for regenerating uplink control information in a cell during a time slot, the method comprising the steps of:
despreading a sequence of spread complex modulation symbols using a set of orthogonal cover code, OCC, sequences, such that at least two of the spread complex modulation symbols are despread using different OCC sequences, thereby generating a sequence of complex modulation symbols; and
mapping the complex modulation symbols to bits corresponding to uplink control information.

13. The method of claim 12, wherein the step of despreading the spread complex modulation symbols comprises selecting an OCC sequence for each spread complex modulation symbol based on a symbol number associated with the spread complex modulation symbol.

14. The method of claim 13, wherein the selection of an OCC sequence for each spread complex modulation symbol is further based on one or more of: cell identity, PUCCH format 3 resource index, slot number, subframe number, RNTI, or frame number.

15. The method of claim 14, wherein the selection of an OCC sequence for each spread complex modulation symbol comprises calculating an OCC sequence index based on a function of the slot number, the symbol number, and a random or pseudo-random value.

16. The method of claim 15, wherein the random or pseudo-random value is generated from a pseudo-random sequence, which has been initialized with a value related to the cell identity.

17. The method of claim 12, further comprising performing cyclic shifting of the spread complex modulation symbols.

18. The method of claim 12, further comprising performing cyclic shifting of the complex modulation symbols after despreading.

19. The method of claim 12, further comprising
receiving a sequence of Single Carrier Frequency Division Multiple Access, SC-FDMA, symbols; and
performing a fast fourier transform on the SC-FDMA symbols: generating a sequence of spread complex modulation symbols by performing an inverse Discrete Fourier Transform, IDFT, operation on one or more of the transformed SC-FDMA symbols.

20. The method of claim 19, further comprising performing cyclic shifting of the input values to the IDFT operation.

21. The method of claim 12, further comprising decoding and/or descrambling the bits.

22. A transmitting node configured to transmit uplink control information in a cell during a time slot, the transmitting node comprising a memory, a transceiver and a processor, wherein the processor is configured to:
map bits corresponding to uplink control information to complex modulation symbols;
spread the complex modulation symbols in the time slot using a set of orthogonal cover code, OCC, sequences, such that at least two of the complex modulation symbols are spread using different OCC sequences; and wherein the transmitter is configured to transmit said uplink control information using said spread complex modulation symbols.

23. The transmitting node of claim 22, wherein the transmitting node is a user equipment or a relay node.

24. A receiving node configured to regenerate uplink control information received in a cell during a time slot, the receiving node comprising a memory, a transceiver and a processor, wherein the processor is configured to:
despread a sequence of spread complex modulation symbols using a set of orthogonal cover code, OCC, sequences, such that at least two of the spread complex modulation symbols are despread using different OCC sequences, thereby generating a sequence of complex modulation symbols; and
map the complex modulation symbols to bits corresponding to uplink control information.

25. The receiving node of claim 24, wherein the receiving node is an eNodeB or a relay node.
